(19) United States
(12) Patent Application Publication
(10) Pub. No.: US 2019/0061267 A1
(43) Pub. Date: Feb. 28, 2019

(54) THERMAL IMAGING DEVICE CALIBRATION

(71) Applicant: HEWLETT-PACKARD DEVELOPMENT COMPANY, L.P., Houston, TX (US)

(72) Inventors: Juan Manuel Valero Navazo, Sant Cugat del Valles (ES); Noel Liarte, Sant Cugat del Valles (ES); Esteve Comas, Sant Quirze Del Valles (ES)

(73) Assignee: HEWLETT-PACKARD DEVELOPMENT COMPANY, L.P., Houston, TX (US)

(21) Appl. No.: 16/071,575

(22) PCT Filed: May 12, 2016
(86) PCT No.: PCT/US2016/032149

§ 371 Date: Jul. 20, 2018

(51) Int. Cl. B29C 64/393; B33Y 50/02; G01J 5/00

(52) U.S. Cl. CPC B29C 64/393; B33Y 50/02; G01J 2005/0077; G01J 2005/0048; G01J 5/00

(57) ABSTRACT

A three-dimensional (3D) printing device may include a thermal imaging device to record an apparent temperature of the a build platform, and a carriage comprising a diffusely reflective material; wherein the thermal imaging device records an apparent reflected temperature of the diffusely reflective material each time the carriage passes over the build platform and corrects an apparent reflected temperature of a build material on the build platform.

### BACKGROUND

Additive manufacturing machines produce three-dimensional (3D) objects by building up layers of material. Some additive manufacturing machines may be referred to as “3D printing devices.” 3D printing devices and other additive manufacturing machines make it possible to convert a computer aided design (CAD) model or other digital representation of an object directly into the physical object.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a block diagram of a three-dimensional (3D) printing device according to an example of the principles described herein.

FIG. 2 is a block diagram of a build platform and thermal imaging device interface within the 3D printing device of FIG. 1 according to one example of the principles described herein.

FIG. 3 is a block diagram of a three-dimensional (3D) printing system according to an example of the principles described herein.

FIG. 4 is a flowchart showing a method for determining calibration data for a thermal imaging device according to one example of the principles described herein.

FIG. 5 is an isometric cut-away view of a three-dimensional (3D) printing device according to an example of the principles described herein.

Throughout the drawings, identical reference numbers designate similar, but not necessarily identical, elements.

### DETAILED DESCRIPTION

Additive manufacturing machines make a 3D object through the solidification of a number of layers of a build material on a build platform within the printing device. Additive manufacturing machines make objects based on data in a 3D model of an object to be generated, for example, with a CAD computer program product. The model data is processed into slices each defining that part of a layer or layers of build material to be solidified. Examples of additive manufacturing described below use a technique where a fusing agent, or coalescing agent, is dispensed onto a layer of build material such as a sinterable material in the desired pattern based on an object slice cross section and then exposed to electromagnetic radiation. The electromagnetic radiation may include infrared light, laser light, or other suitable electromagnetic radiation. Energy absorbing components in the fusing agent absorb the electromagnetic radiation to generate additional heat that fuses, sinters, melts, or otherwise coalesces the patterned build material, allowing the patterned build material to solidify.

In some examples, heating of the build material may occur in two processes. In a first process, the build material may be heated to and maintained at a temperature just below the build material's fusing or coalescing temperature. In a second process, a fusing agent is “printed” or otherwise dispensed on to the build material in the desired pattern and exposed to another, relatively, higher intensity electromagnetic radiation source. This relatively higher intensity light is absorbed into the patterned coalescing agent causing the build material on which fusing agent was applied to coalesce and solidify. Halogen lamps emitting light over a broad spectrum may be used, for example, in both these processes.

With these 3D printing devices, higher quality of printed 3D objects can be achieved when the temperature of the build material is maintained at a predefined temperature over an entire layer of build material prior to sintering. In an example, that temperature may be a temperature just below the build material's coalescing temperature. In one example, this temperature may be 2° to 3° C. away from the build material's coalescing temperature. Any cooler, and the sintering of the build material may not occur. Any hotter, and fusing of the build material may not be completed correctly causing deformation of the 3D object being formed.

Some 3D printing device may use pyrometers to measure the temperature of a build material on a build platform, while other 3D printing devices may use a thermal camera to measure an entire surface of the build platform or at least more points on the printing be than could be monitored by a pyrometer. The accuracy of thermal camera readings of the temperature of the build material along the build platform may be compromised by a number of factors. These factors may include reflected energy onto the surface of the layer of build material, the absorbance and emittance of the atmosphere between the layer of build material and thermal camera, among others.

These factors affect the accuracy of the temperature readings of the thermal camera. In order to compensate for additional emissivity detected from the build material originating from these other sources, the present specification describes a 3D printing system and arrangement for ensuring good temperature readings from the internal non-contact temperature measurement device such as a thermal camera, pyrometer, array of pyrometers, and other thermal imaging devices, by correcting for any reflected energy directed to the thermal cameras.

The present specification, therefore describes a three-dimensional (3D) printing device that may include a thermal imaging device to record an apparent temperature of the a build platform, and a carriage comprising a diffusely reflective material; wherein the thermal imaging device records an apparent reflected temperature of the diffusely reflective material each time the carriage passes over the build platform and corrects an apparent reflected temperature of a build material on the build platform.

In another example, the present specification further describes a method for determining calibration data for a thermal imaging device including detecting, with a thermal imaging device of a printing device, an apparent reflected temperature of a diffusely reflective material opposite the thermal imaging device as the diffusely reflective material traverses a build platform, measuring an ambient temperature within a chamber of the printing device, and using an apparent reflective temperature of a build material, the apparent reflected temperature of the diffusely reflective material and the ambient temperature as calibration data to calibrate the thermal imaging device.

In a further example, the present specification describes a three-dimensional (3D) printing system including a processor to receive, from a thermal imaging device, an apparent temperature of a diffusely reflective material on a carriage as the carriage passes over a build platform, receive an ambient temperature within a printing chamber of the 3D printing system, and calculate calibration data for the thermal imaging device using the apparent temperature of the diffusely reflective material and the ambient temperature.

As used in the present specification and in the appended claims, the term “emission” or “emissivity” is meant to be understood as the measure of an object's ability to emit infrared energy. Emitted energy may indicate the temperature of the object. In an example, emissivity can have a value from 0 (shiny mirror) to 1.0 (blackbody). The emissivity of a material is the relative ability of its surface to emit energy by radiation. It is the ratio of energy radiated by a particular material to energy radiated by a black body at the same temperature. It is a measure of a material's ability to radiate absorbed energy. A true black body would have an emissivity equal to 1 while any real object would have an emissivity less than 1. Emissivity is a dimensionless quantity, so it does not have units. In general, the duller and blacker a material is, the closer its emissivity is to 1. The more reflective a material is, the lower its emissivity. In other words, reflectivity is inversely related to emissivity and when added together their total should equal 1.

Additionally, as used in the present specification and in the appended claims, the term “fuse” is meant to be understood as bringing together or joining a coherent mass. In an example, a build material may be fused by heating, for example by sintering or melting.

Further, as used in the present specification and in the appended claims, the term “fusing agent” is meant to be understood as a substance that causes or helps cause a build material to coalesce.

Even still further, as used in the present specification and in the appended claims, the term “a number of” or similar language is meant to be understood broadly as any positive number including 1 to infinity.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

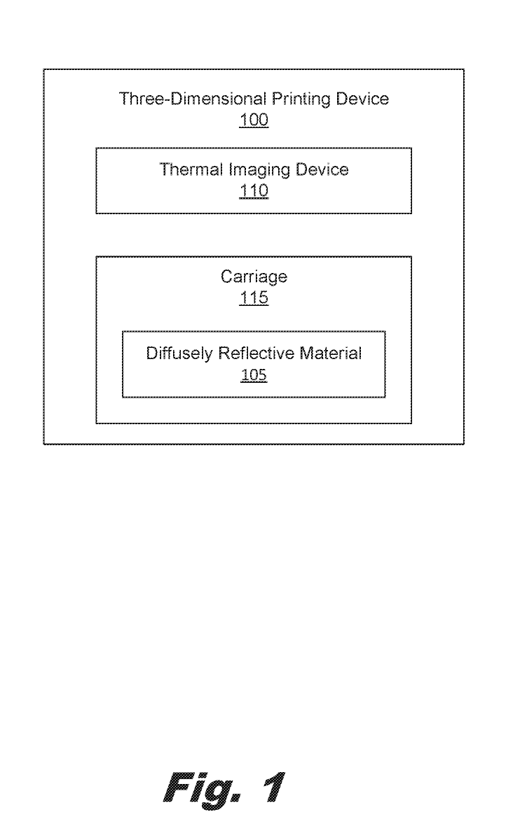

Turning now to the figures, FIG. 1 is a block diagram of a three-dimensional (3D) printing device (100) according to an example of the principles described herein. The 3D printing device (100) may include a thermal imaging device (110) and a carriage (115) including a diffusely reflective material. Each of these will now be described in more detail.

The thermal imaging device (110) may be any type of imaging device that can detect electromagnetic radiation such as infrared radiation emitting from a layer of build material on the surface of a build platform. Any number of thermal imaging devices (110) may be used to detect the whole or a portion of the entire surface of the build platform. In an example, the thermal imaging device (110) detects electromagnetic radiation emitting from the build platform having wavelengths up to 14,000 nm. In this example, the imaging device continuously detects this emitted infrared radiation along the entirety of the build platform. In an example, an array of pyrometers may be used with each pyrometer detecting the emissivity of a single point on the surface of the build platform. In this example, the number of pixels of temperature data may depend on the number of pyrometers in the array. In another example, the thermal imaging device (110) may be a thermal camera capable of detecting the temperature of the whole surface of the build platform and provide a single image to a user of the 3D printing device. In this example, a single pixel may represent an average temperature of a section of build material portion on the build platform: the section being smaller than the whole of the build platform.

The carriage (115) may be any type of device that crosses between the thermal imaging device (110) and the build platform. In one example, the carriage (115) is a build material layering device that forms layers of build material on the build platform. In this example, the build material layering device may include a roller to receive an amount of build material and roll out a thin layer onto a top surface of the build platform. In this example, the surface of the roller that contacts the build material may move in the same direction that the build material layering device progresses across the build platform. Here, the rotation of the roller is against the movement of the build material layering device causing the build material to be spread out over the build platform. In an example, the build material layering device may be a straight edge that pushes an amount of build material over the build platform so as to form a uniformly thick layer of build material over the build platform or another layer of build material.

The carriage (115) may further include a housing. The housing provides a stable structure for, in an example, the roller as well as protect the roller from damage from a number heating lamps heating the build material on the build platform.

The housing of the carriage (115) includes a top surface facing the thermal imaging device (110) and facing away from the build platform. The top surface may include a diffusely reflective material (105) that reflects all or mostly all of the electromagnetic radiation that is otherwise absorbed by the build material on the build material bed (105). In an example, the reflectivity and/or emissivity of the diffusely reflective material (105) is known. In this example, the diffusely reflectivity of the material may be at 90% or greater. In an example, the diffusely reflective material (105) is MIRO® 20. MIRO® 20 is a reflective surface treatment created by Alanod. In an example, the diffusely reflective material (105) is MIRO® 9. MIRO® 20 and 9 comprise aluminum as part of the diffusely reflective material. Where a diffusely reflective material (105) is used, the reflectivity and/or emissivity of the diffusely reflective material may be known prior to operation of the 3D printing device (100). As will be described in more detail below, this known reflectivity and/or emissivity of the diffusely reflective material (105) may be used to calibrate the thermal imaging device (110).

During operation, not all of the energy applied to the build material on the build platform may originate from the heating lamps. Instead, some the energy may originate from, for example, a glass separating the heat lamps from the build platform and the rest of the 3D printing device (100). Additionally, energy may be emitted by the atmosphere between the build platform and heat lamps. Further, energy may be emitted by other parts of the 3D printing device (100) and directed to the surface of the build material on the build platform. Additional sources of energy may exist all of which cause the build material to heat up beyond that caused by the heat lamps alone. This increases the apparent reflected temperature of the build material on the build platform. It is this additional energy that the diffusely reflective material (105) on the housing of the carriage (115) reflects back to the thermal imaging device (110). This reflected energy reflected by the diffusely reflective material (105) is known as the reflected apparent temperature of the diffusely reflective material (105). As will be discussed below, this

The build platform may be any type of surface onto which a build material such may be layered. As mentioned above, the build platform may accommodate any number of layers of build material and fusing agent: a layer of each deposited on the build platform at a time in order to form different layers of the 3D object. In an example, a number of build material supply receptacles may be positioned alongside the build platform. As will be described in more detail below, a build material layering device may receive an amount of build material from the build material supply receptacles and form a first or a new layer of build material onto the build platform. In an example, the build platform may include a removable trolley that may be selectively engaged with the 3D printing device (100) during operation. In an example, the build platform may be integrated into the 3D printing device (100).

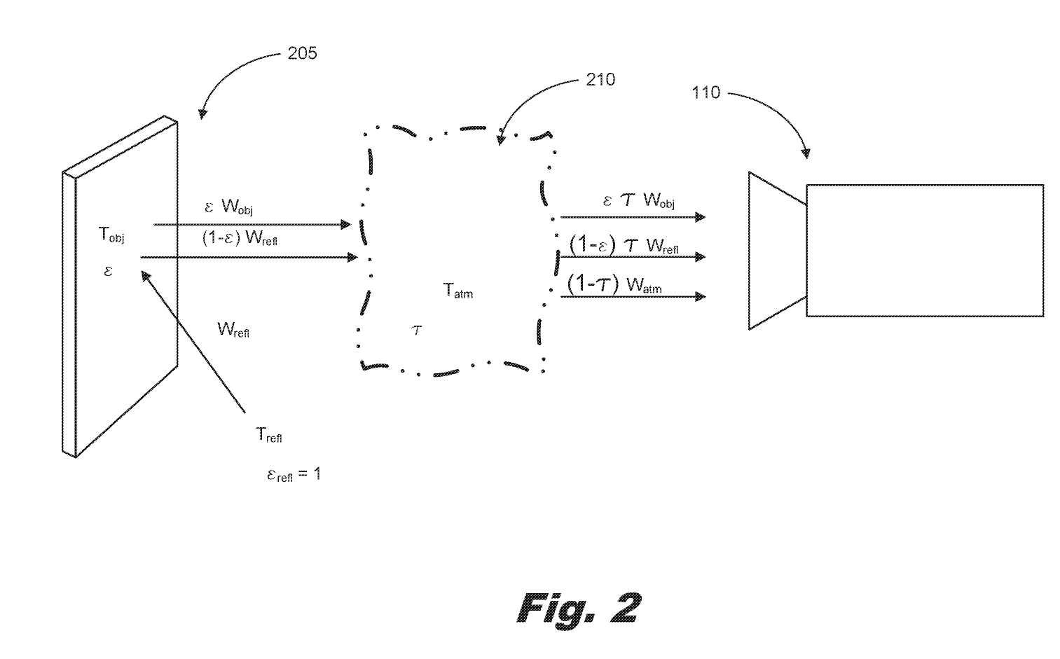

FIG. 2 is a block diagram of a build platform (205) and thermal imaging device (110) interface within the 3D printing device of FIG. 1 according to one example of the principles described herein. As described above, not all of the heat emitted from the build platform (205) is from the heating lamps. Instead, reflected energy (T_{reff}) is also added to the build platform (205). Further, the atmosphere (210) emits energy and also subtracts energy from the total emissive energy detected by the thermal imaging device (110). With the diffusely reflective material on the carriage, an equation may be used to account for this additional energy applied to the surface of the build platform (205) and changes in the apparent reflected temperature of the build platform (205) due to other sources such as the atmosphere (210). The equation is as follows:

$${T}_{obj} = \frac{{T}_{total} - ( ( 1 - ɛ ) \times {T}_{refl} ) - ( ( 1 - τ ) \times {T}_{atm} )}{ɛ \times τ} \qquad ( Eq . 1 )$$

where T_{obj} is the temperature of the build material; Tₜₒₜₐₗ is the total apparent temperature of the build material recorded by the thermal imaging device; T_{reff} is the apparent reflected temperature of the diffusely reflective material; Tₐₜₘ is a temperature of the atmosphere between the build platform and the thermal imaging device; e is the emissivity of the surface of the build material; and τ is the transmission of the atmosphere (210). With this equation (Eq. 1), all of the energy emitted from the heat lamps onto the build platform (205) may be accounted for and the remainder of the emissive energy from the surface of the build platform (205) may be determined. With this additional emissive heat determined, a processor associated with the 3D printing device (FIG. 1, 100) may calibrate the thermal imaging device (110) correcting each temperature value at each pixel.

Because the diffusely reflective material is on the carriage (FIG. 1, 115), the calibration of the thermal imaging device (110) may occur each time and while the carriage (FIG. 1, 115) adds a layer of build material to the build platform. In an example, this calibration process described above may occur each time a new layer of build material is added to the build platform in order to form a new layer of the 3D object being formed in the 3D printing device (FIG. 1, 100).

In an example, the 3D printing device (FIG. 1, 100) further includes a printhead used to eject a fusing agent onto a newly formed layer of build material on the build platform (205). This printhead may be any type of printhead suitable to selectively eject the fusing agent along the entire surface of the build platform (205). In an example, the printhead may be a build platform-wide array printhead. In an example, the printhead or a housing of the printhead may also include a diffusely reflective material similar to that on the carriage (FIG. 1, 115) described above. In this example, the calibration process described above may also be accomplished as the printhead moves across the build platform (205). Thus, in this example, the calibration of the thermal imaging device (110) with regard to the actual temperature of the build material across the build platform (205) may be accomplished. Because each of the carriage (FIG. 1, 115) and printhead cross the surface of the build platform (205) once for every layer of the 3D object being formed by the 3D printing device (FIG. 1, 100), the calibration process described above may be accomplished a relatively higher number of times.

As mentioned above, a processor associated with the 3D printing device (FIG. 1, 100) may adjust the detected apparent reflective temperature of the build platform using the ambient temperature (Tₐₜₘ), the apparent temperature of the build material (Tₜₒₜₐₗ), and the known apparent reflected temperature of the diffusely reflective material (T_{reff}). As described above, the reflectivity and/or emissivity of the diffusely reflective material (FIG. 1, 105) is known prior to calibration and is used in connection with Equation 1 above to calibrate the thermal imaging device (110).

Additionally, during operation, the processor may serve to provide instructions to a number of other devices associated with the 3D printing device (FIG. 1, 100) to accomplish the functionality of the 3D printing device (FIG. 1, 100). Specifically, the processor may direct a number of heat lamps to selectively and individually turn on, turn off, increase emitted electromagnetic radiation output, and/or decrease emitted electromagnetic radiation output. Additionally, the processor may direct the carriage (FIG. 1, 115) such as a build material layering device to form a layer or an additional layer of build material onto the build platform (205). Further, the processor may send instructions to direct the printhead to selectively eject the fusing agent onto the surface of a layer of build material. The processor may also direct the printhead to eject the fusing agent at specific locations along the build platform (205). The processor may further collect the apparent reflective temperature data from the diffusely reflective material and the build platform (205) described above and calculate how to calibrate the thermal imaging device (110).

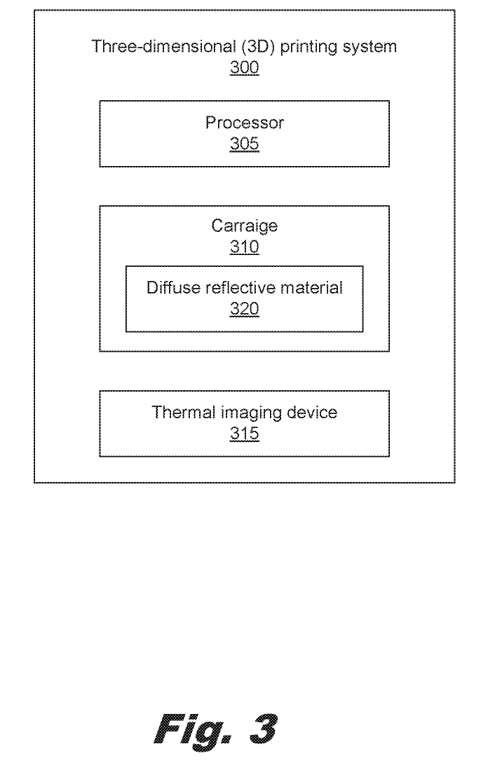

FIG. 3 is a block diagram of a three-dimensional (3D) printing system (300) according to an example of the principles described herein. The 3D printing system (300) may include a thermal imaging device (315), a processor (305), a carriage (310), and a number of infrared lamps. Each of these will now be described in more detail.

The processor (305) may include the hardware architecture to retrieve executable code from a data storage device and execute the executable code. The executable code may, when executed by the processor (305), cause the processor (305) to implement at least the functionality of receiving a detected apparent temperature from a build material on a build platform and a diffusely reflective material (320) on device carriage (310) with a thermal imaging device (315). The processor may also receive an ambient temperature value within a printing chamber and calibrate a thermal imaging device (315) according to the methods of the present specification described herein. In the course of executing code, the processor (305) may receive input from and provide output to a number of the remaining hardware units.

As described above, the carriage (310) may be a dedicated carriage to traverse the diffusely reflective material (320) across the build platform, a build material layering device having a surface coated with the diffusely reflective material (320), or a printhead having a surface coated with the diffusely reflective material (320). Where carriage (320) is a build material layering device, the build material layering device may receive an amount of build material from a number of build material supply receptacles and deposit a number of layers of build material onto a build platform (205). In this example, the build material layering device may further include a housing having the diffuse reflective material facing the thermal imaging device (315). In one example the diffusely reflective material may have a known reflectivity or emissivity. The diffusely reflective material may have an emissivity value close to or equal to 0. In an example, the emissivity value is between 0 and 5%. In another example, the emissivity value is between 0 and 10%.

As described above, the diffusely reflective material (320) reflects a known amount of energy emitted from the infrared lamps towards a thermal imaging device (315). The apparent reflected temperature detected from the diffusely reflective material (320) includes that energy produced by the number of radiation sources other than the actual temperature of the build material on the build platform (FIG. 2, 205).

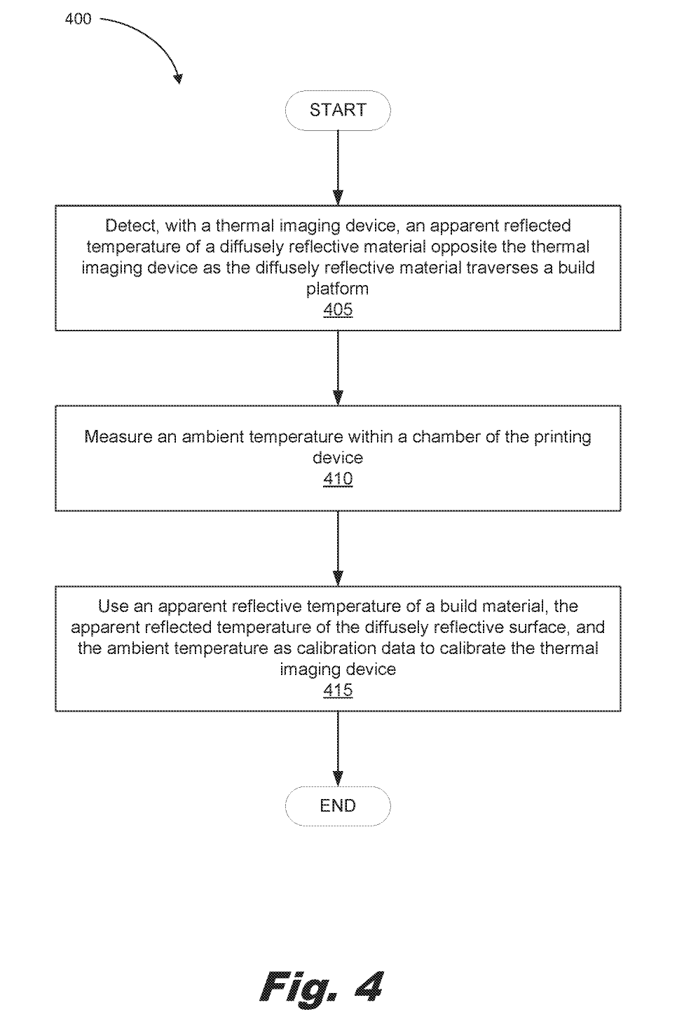

FIG. 4 is a flowchart showing a method (400) for determining calibration data for a thermal imaging device according to one example of the principles described herein. The method (400) may begin with detecting (405), with a thermal imaging device, an apparent reflected temperature of a diffusely reflective material opposite the thermal imaging device as the diffusely reflective material traverses or scans across a build platform. As described above, this diffusely reflective material may be placed on a build material layering device, a carriage (FIG. 1, 115), a printhead device, or a combination of each of these devices. During operation of a 3D printing device (FIG. 1, 100), the thermal imaging device (FIG. 1, 110) may detect the apparent temperature of the build material deposited by, for example, the build material layering device on the build platform. As the build material layering device applies a layer or a new layer of build material onto the build platform and scans across the build platform, the apparent reflected temperature of the diffusely reflective material is detected (405). As will be discussed in more detail below, the diffuse reflective material is scanned across the field of view of the thermal imaging device building up a full picture of the accuracy or inaccuracy of the readings provided by the thermal imaging device. In an example, the temperature readings of the diffuse reflective material as it is scanned across the build platform are used to calibrate the thermal imaging device.

In an example, the processor (FIG. 3, 305) may continually receive input from the thermal imaging device (FIG. 1, 110) regarding the apparent reflected temperature of the build material on the build platform. As the calibration method described herein progresses, the processor (FIG. 3, 305) may cause each of the infrared lamps (315) to individually increase or decrease their irradiance (W/m²) as needed to increase or decrease the temperature of the build material. For example, as a new layer of build material is added to the 3D object, the processor (FIG. 3, 305) may determine before or after the calibration process that the new build material should be heated up in preparation to receive the fusing agent for fusing. As the diffuse reflective material (FIG. 3, 320) passes under each infrared lamp, the irradiance of each of the infrared lamps may be determined and/or adjusted. Adjustment of the infrared lamps may be done to adjust the infrared lamps to a known and predetermined irradiance as the carriage (FIG. 3, 310) passes thereunder. With the infrared lamps set to a known irradiance value, the apparent reflected temperature from the diffuse reflective material (FIG. 3, 320) may be used during the calibration. In this example, different irradiances may cause different apparent reflected temperature readings from the diffusely reflective material (FIG. 3, 320). A look-up table or other data may provide to the processor (FIG. 3, 305) to determine how the total apparent reflective temperature of the build material (Tₜₒₜₐₗ) should be adjusted to get the true temperature of the build material based on the apparent reflected temperature readings from the diffusely reflective material (FIG. 3, 320) at a known irradiance level.

The method (400) may continue with measuring (410) an ambient temperature within a chamber of the printing device where the 3D object is being formed. The ambient temperature may be detected by an internal ambient temperature sensor such as a digital thermometer. The ambient temperature may be used to help in the calibration of the thermal imaging device (FIG. 1, 110) according to equation 1 described above. In an example, the internal ambient temperature sensor may also be used to regulate a speed of a cooling fan in order to maintain or control an internal control of temperature.

The method (400) may continue with using (415) an apparent reflective temperature of the build material, the apparent reflected temperature of the diffusely reflective material, and the ambient temperature as calibration data to calibrate the thermal imaging device (FIG. 1, 110). Equation 1 above may be used to complete this calibration process. When the processor (FIG. 3, 305) executes this calibration process using equation 1 above, each temperature value for each pixel of the thermal imaging device (FIG. 1, 110) may be calibrated to detect the correct temperature of the build material bed (FIG. 1, 105). In an example, readings of the thermal imaging device allow a user to see the effect of all infrared lamps on the build material bed (FIG. 1, 105). In an example, temperature readings on the thermal imaging device may allow a user to see the effects of one of the infrared lamps emitting infrared energy on an area of the build material bed (FIG. 1, 105). In an example, temperature readings on the thermal imaging device may allow a user to see the effects of a plurality of infrared lamps emitting infrared energy on an area of the build material bed (FIG. 1, 105).

The positioning of the diffusely reflective material (320) on the carriage (310) allows the calibration of the readings of the thermal imaging device (FIG. 1, 110) to be conducted on the fly at any frequency detected by the thermal imaging device (FIG. 1, 110). In an example, calibration of the thermal imaging device (FIG. 1, 110) may occur for any type of build material used to build the 3D object on the build platform. Because different build materials may have different coalescing temperatures and respective near-coalescing temperatures, the thermal imaging device (FIG. 1, 110) calibration method and systems described herein may be conducted for a wide variety of different build materials without extra information being presented to the processor (FIG. 3, 305) by a user.

Additionally, the diffusely reflective material (320) may prevent certain devices within the carriage (FIG. 1, 115), such as a roller, from being heated by the infrared lamps thereby preventing mechanical deformation of those internal parts. Additionally, the diffusely reflective material (320) may prevent any build material from sticking to the internal parts of the carriage (FIG. 1, 115) such as the roller when the carriage traverses or scans across the build platform.

In an example, all pixels of the thermal imaging device (FIG. 1, 110) cover the entire build platform. The carriage (115), therefore, passes over the entirety of the build platform as the build material is layered on the build platform as described above. In an example, the calibration of the thermal imaging device (FIG. 1, 110) may be conducted pixel-by-pixel as the carriage (310) scans over the build platform allowing for a relatively more finite calibration of the thermal imaging device (FIG. 1, 110).

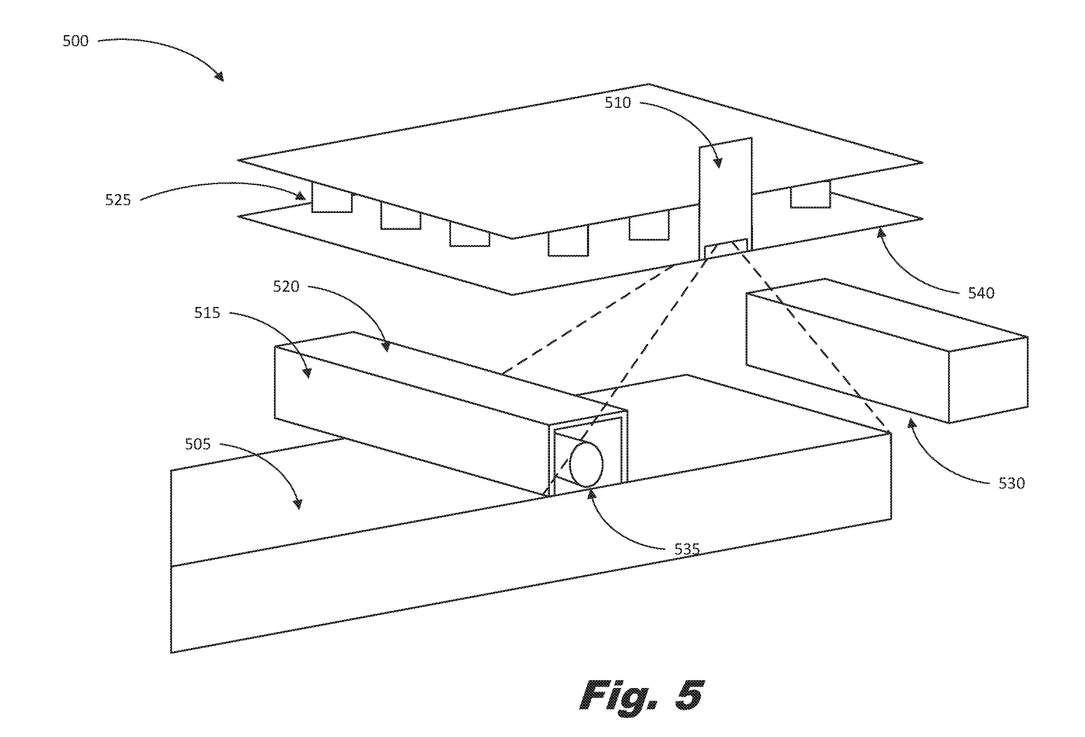

FIG. 5 is an isometric cut-away view of a three-dimensional (3D) printing device (500) according to an example of the principles described herein. As described above the 3D printing device (500) includes a build platform (505), a thermal imaging device (510), a carriage (515) with a roller (535) and a diffusely reflective material (520) facing the thermal imaging device (510), a number of electromagnetic radiation emitting lights (525), and a printhead (530). The interaction between each of these will now be described in more detail.

During operation, the thermal imaging device (510) may be continually monitoring the temperature of the build material layered on the build platform (505). The thermal imaging device (510) is monitoring the infrared radiation emitted by the build material as the build material is heated up by the electromagnetic radiation emitting lights (525) to a temperature about 2° to 3° C. below the build materials' fusing temperature. However, as described above, the apparent temperature of the build material on the build platform (505) may not be accurate due to a number of additional heat sources apart from the electromagnetic radiation emitting lights (525). This inaccuracy results from the atmosphere between the thermal imaging device (510) and build platform (505), reflected energy from surrounding surfaces in the 3D printing device (500), and energy emitted by a pane of glass (540) separating the electromagnetic radiation emitting lights (525) from the interior of the 3D printing device (500), among other sources.

To calibrate the thermal imaging device (510), the carriage (515) scans over the build platform (505). The diffusely reflective material (520) of the carriage (515) is monitored by the thermal imaging device (510) as it passes over every portion of the build platform (505) and while, in one example, it forms a layer of build material onto the build platform (505). While the carriage (515) passes over the build platform (505), an ambient temperature sensor within the 3D printing device (500) monitors the ambient temperature within the 3D printing device (500). The apparent reflected temperature of the diffusely reflective material (520) is then provided to the processor (FIG. 3, 305) along with the ambient temperature reading from the ambient temperature sensor. With the data, the processor (FIG. 3, 305) determines calibration data for each pixel value of the thermal imaging device (510) according the equation (Eq. 1) described above. The temperature values for each pixel of the thermal imaging device (510) are then calibrated according to the output of that equation and the true temperature of the build material on the build platform (505) is known. Using this calibration method, the temperature of the build material may be more accurately controlled. Consequently, this produces a relatively better manufactured 3D object.

As described above, the printhead (530) may also pass across the entirety of the build platform (505) in order to deposit a fusing agent onto the surface of a first or newly formed layer of build material. In an example, the fusing agent absorbs additional energy from a number of electromagnetic radiation emitting lights on the printhead (530). As this additional energy is absorbed by the fusing agent, the fusing agent begins to heat any contacting build material to a temperate equal to or above the build materials' coalescing temperature. This melts, sinters, or otherwise coalesces the build material causing a portion of the 3D object to be formed. As also described above, the printhead (530) may have a diffusely reflective material (520) placed on an upper surface of a housing of the printhead (530) as well. This additional diffusely reflective material (520) may provide for the calibration process to be conducted each time the printhead (530) passes over the build platform (505). Consequently, this allows the calibration process to be conducted at least twice for each layer of the 3D object being formed.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (FIG. 3, 305) of the 3D printing system (FIG. 3, 300; FIG. 5, 500) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a three-dimensional (3D) printing device with a diffusely reflective material (520) on a carriage (515) used to calibrate a thermal imaging device (510) within the system. A method of calibrating the thermal imaging device (510) is also described. This system and method allows for accurate and consistent build material temperatures across the build platform (505). The permanency of the reflective surface on the carriage allows the calibration of the readings of the thermal imaging device to be conducted on the fly at any frequency detected by the thermal imaging device. The calibration of the thermal imaging device may occur for any type of build material used to build the 3D object on the build platform. Because different build materials may have different coalescing temperatures and respective near-coalescing temperatures, the thermal imaging device calibration method and systems described herein may be conducted for a wide variety of different build materials without extra information being presented to the processor by a user. Additionally, the diffusely reflective material may prevent certain devices within, for example, a build material layering device such as a roller from being heated by the infrared lamps thereby preventing mechanical deformation of those internal parts. Additionally, the diffusely reflective material may prevent any build material from sticking to the internal parts of, for example, the build material layering device and the roller.

The preceding description has been presented to illustrate and describe examples of the principles described. This description is not intended to be exhaustive or to limit these principles to any precise form disclosed. Many modifications and variations are possible in light of the above teaching.

What is claimed is:

1. A three-dimensional (3D) printing device, comprising:
a thermal imaging device to record an apparent temperature of a top layer of build material on a build platform; and
a carriage comprising a diffusely reflective material;
wherein the thermal imaging device records an apparent reflected temperature of the diffusely reflective material each time the carriage passes over the build platform and an apparent reflected temperature of a build material on the build platform is corrected.

2. The 3D printing device of claim 1, wherein the correction of the apparent temperature of the build platform by the apparent reflected temperature of the diffusely reflective material is accomplished according to the following equation:
$${T}_{obj} = \frac{{T}_{total} - ( ( 1 - ɛ ) \times {T}_{refl} ) - ( ( 1 - τ ) \times {T}_{atm} )}{ɛ \times τ}$$
where T_{obj} is the temperature of the build platform; Tₜₒₜₐₗ is a total apparent temperature of the build platform recorded by the thermal imaging device; T_{reff} is the apparent reflected temperature of the diffusely reflective material; Tₐₜₘ is a temperature of the atmosphere between the build platform and the thermal imaging device; e is the emissivity of the surface of the build platform; and τ is the transmission of the atmosphere.

3. The 3D printing device of claim 1, further comprising a processor to receive the recorded apparent reflected temperature of the diffusely reflective material, the temperature of the atmosphere between the build platform and the thermal imaging device, and the total apparent temperature of the build platform recorded by the thermal imaging device and calculate the calibration data according to the equation.

4. The 3D printing device of claim 1, further comprising a number of infrared electromagnetic radiation emitters to heat the build platform.

5. The 3D printing device of claim 4, wherein the electromagnetic radiation emitted from each number of infrared electromagnetic radiation emitters are individually adjustable to adjust the amount of heat applied to a portion of the build platform.

6. The 3D printing device of claim 1, wherein the carriage is a build material layering device to deposit a new layer of build material onto the build platform.

7. A method for determining calibration data for a thermal imaging, comprising:
detecting, with a thermal imaging device of a printing device, an apparent reflected temperature of a diffusely reflective material opposite the thermal imaging device as the diffusely reflective material traverses a build platform;
measuring an ambient temperature within a chamber of the printing device; and
using an apparent reflective temperature of a build material, the apparent reflected temperature of the diffusely reflective material and the ambient temperature as calibration data to calibrate the thermal imaging device.

8. The method of claim 7, further comprising emitting electromagnetic radiation from a number of electromagnetic radiation emitters onto the build material.

9. The method of claim 7, wherein the reflective surface is applied to a surface of a build material layering device.

10. The method of claim 9, wherein detecting the apparent reflected temperature of the diffusely reflective material is accomplished each time the build material layering device applies a layer of build material to a build platform within the printing device.

11. The method of claim 7, wherein the diffusely reflective material is made of aluminum.

12. The method of claim 8, wherein an irradiance of each of the electromagnetic radiation emitters is known as the diffusely reflective material passes underneath each of the electromagnetic radiation emitters.

13. A three-dimensional (3D) printing system, comprising:
a processor to:
receive, from a thermal imaging device, an apparent temperature of a diffusely reflective material on a carriage as the carriage passes over a build platform;
receive an ambient temperature within a printing chamber of the 3D printing system; and
calculate calibration data for the thermal imaging device using the apparent temperature of the diffusely reflective material and the ambient temperature.

14. The 3D printing system of claim 13, further comprising a fusing agent dispersing device to selectively deposit a fusing agent onto a surface of a layer of build material deposited by the carriage onto the build platform.

15. The 3D printing system of claim 14, wherein the fusing agent dispersing device further comprises a diffusely reflective material and wherein the processor:
receives, from a thermal imaging device, an apparent temperature of the diffusely reflective material on the fusing agent dispersing device;
receives an ambient temperature within the printing chamber; and
calculates calibration data using the apparent temperature of the aluminum surface on the fusing agent dispersing device and the ambient temperature.
